(19) United States
(12) Patent Application Publication
(10) Pub. No.: US 2003/0203659 A1
(43) Pub. Date: Oct. 30, 2003

(54) Connector for memory cartridge

(76) Inventor: Chih-Chiang Wang, Ping-Chen City (TW)

Correspondence Address: BACON & THOMAS, PLLC, 625 SLATERS LANE, FOURTH FLOOR, ALEXANDRIA, VA, 22314

(21) Appl. No.: 10/134,386

(22) Filed: Apr. 30, 2002

(51) Int. Cl. H01R 12/00

(52) U.S. Cl. 439/64

(57) ABSTRACT

In a memory cartridge connector having a U-shaped body, terminals, a substrate and connecting pins, the U shaped body has through holes defined therethrough for insertion of the terminals which extend from opposite sides of the body. The rear ends of the terminals connect to the substrate. The body has passages defined in a bottom of the body, wherein a width and a depth of the passages are the same as those of the connecting pins. One end of the connecting pin is received in a corresponding one of the passages and extends out of the body, the other end of the connecting pin connects to a corresponding one of the terminals, whereby after all the connecting pins are received in the passages, a portion of the connecting pin is supported in the passage so that after all the connecting pins are supported by the passages so that the connecting pins are at the same level.

### FIELD OF THE INVENTION

The present invention relates to a connector, and more particularly to a connector for use with a memory cartridge.

### BACKGROUND OF THE INVENTION

With reference to FIG. 1, a conventional connector 1 for a memory cartridge has a body 11 and connecting terminals 12 each having a first end extending out of the body 11 for connection with a memory cartridge and a second end for connecting the connector 1 to a substrate (not shown). The connecting terminals 12 are often bent when mounted on the body 11 or during shipment such that when the connecting terminals 12 are welded on the body 11, distal ends 121,122 of the connecting terminals 12 are not able to be kept in the same level, which inevitably leads to bad connection with the substrate.

With reference to FIG. 2, another approach is adopted to the conventional connector 1, which tries to overcome the previous drawback. The connector 1, as shown in FIG. 1, connects to a secondary substrate 13 and then the secondary substrate 13 is inserted into a connector relay 14 securely mounted on the substrate 15. The connection of the connector 1 to the secondary substrate 13 is trying to maintain all the connecting terminals 12 in the same level so that when the connector 1 is connecting to a substrate (15), the connection therebetween is satisfactory.

FIG. 3 still shows a conventional connector, which uses the secondary substrate 13 for connection with the connecting terminals 12, the connector relay 141 for connection with the secondary substrate 13 and a secondary connector relay 142 on the substrate 15 for connection with the connector relay 141 so that the connector 1 is able to connect to the substrate 15. All these additional elements are trying to maintain the connecting terminals 12 at the same level so as to reach a good connection with the substrate 15. However, additional elements means additional cost for manufacturing the elements, more cost for storage, shipment and, of course, for installation.

To overcome the shortcomings, the present invention intends to provide an improved safety syringe to mitigate or obviate the aforementioned problems.

### SUMMARY OF THE INVENTION

The primary objective of the invention is to provide an improved connector for memory cartridge. The connector is able to maintain the connecting pins at the same level so as to have a good connection with the substrate.

In order to accomplish the objective, the connector of the present invention has a U shaped body, terminals inserted into the body to connect to a substrate securely mounted on the body and connecting pins a first end of which is inserted into the pin hole in the substrate and a second end of which extends out of the body. With the arrangement, the connection between the connecting pins and the terminals is established.

Other objects, advantages and novel features of the invention will become more apparent from the following detailed description when taken in conjunction with the accompanying drawings.

### BRIEF DESCRIPTION OF THE DRAWINGS

FIG. 1 is a side view of a conventional connector;

FIG. 2 is a side view of a second conventional connector;

FIG. 3 is a side view of a third conventional connector;

FIG. 4 is a front plan view of a connector of the present invention;

FIG. 5 is a bottom side view of the connector in FIG. 4;

FIG. 6 is a side view in partial section of the connector in FIG. 4; and

FIG. 7 is a schematic view showing the application of the connector of the present invention.

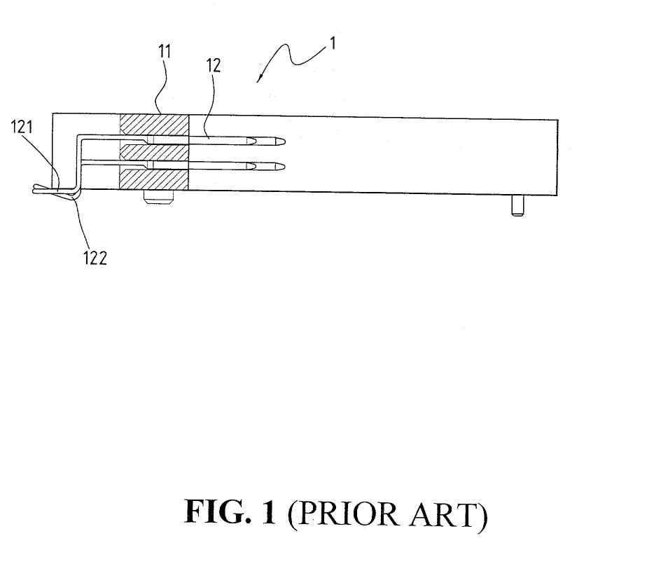

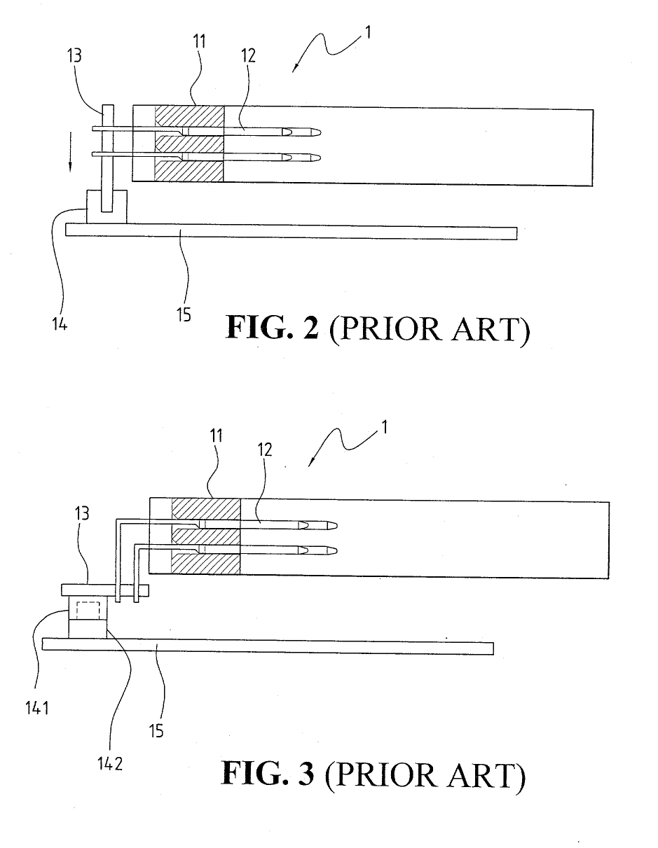

### DETAILED DESCRIPTION OF THE INVENTION

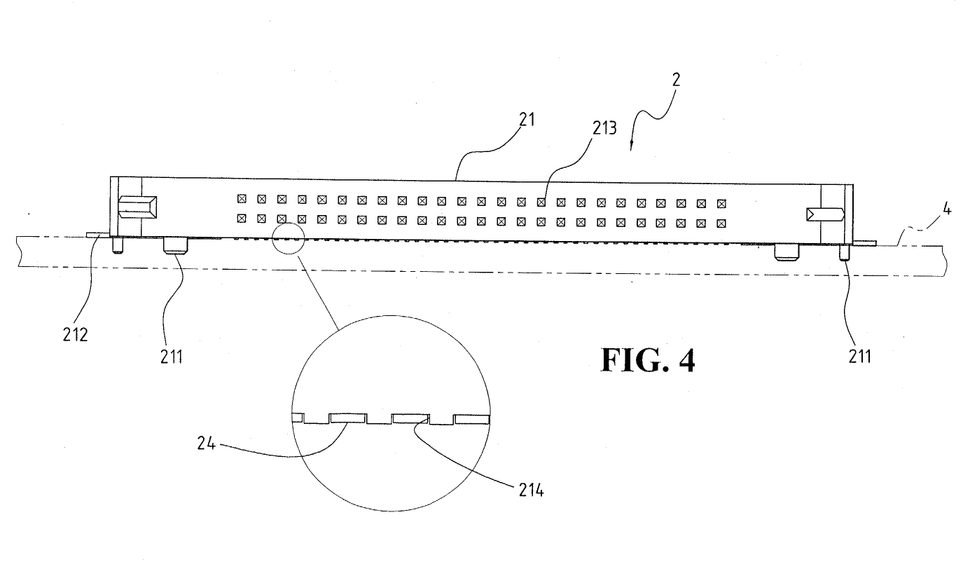

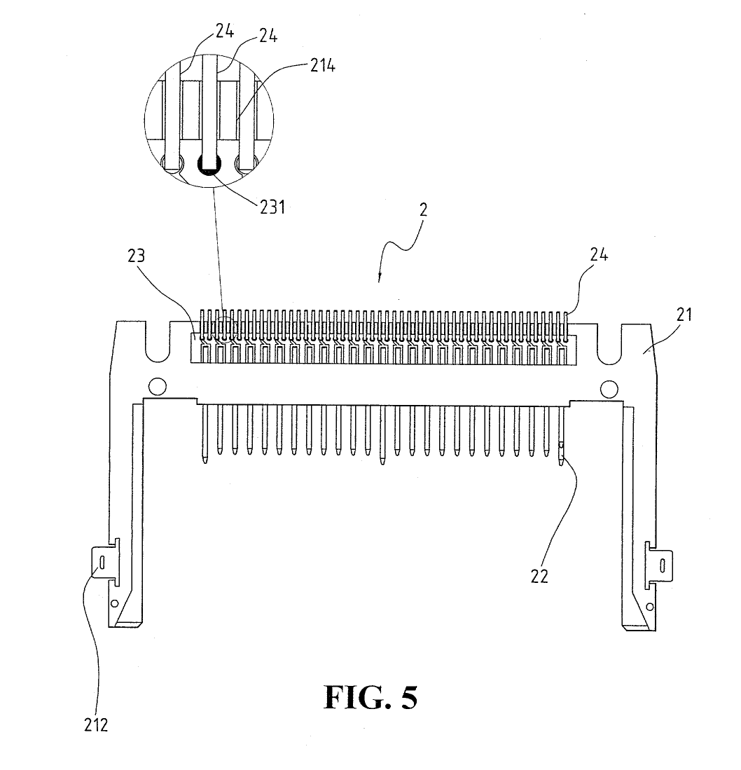

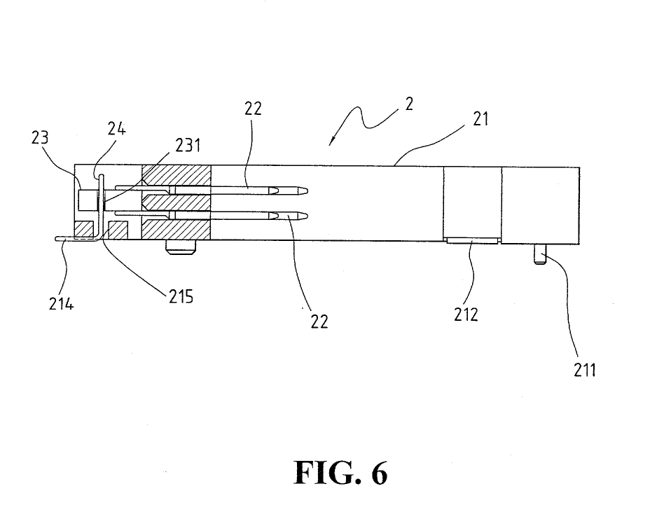

With reference to FIGS. 4 and 5, the connector 2 in accordance with the present invention has a body 21, terminals 22, a substrate 23 and connecting pins 24.

The body 21 is U shape and is so configured that a memory cartridge (not shown) is able to be inserted therein. The body has positioning rods 211 and positioning plates 212 formed on a bottom face the body 21. With the provision of the positioning rods 211 and the positioning plates 212, the body 21 is able to be securely and accurately mounted on top of a main board 4. The body 21 further has through holes 213 defined therethrough for insertion of the terminals 22. When the terminals 22 are inserted into the through holes 213, both front and rear ends of the terminals 22 extend from opposite sides of the body 21. The rear ends of the terminals 22 connects to the substrate 23. With reference to an enlarged side view of FIG. 4, the body 21 still has passages 214 defined in the bottom of the body 21. The width and depth of the apertures 214 is the same as those of the connecting pins 24.

The connecting pin 24 is L shape. One end of the connecting pin 24 is received in a corresponding one of the passages 214 and extends out of the body 21. With reference to an enlarged side view of FIG. 5, the other end of the connecting pin 24 connects to a corresponding one of the terminals 22 via a through hole 231 defined in the substrate 23 to communicate with the passage 214. When all the connecting pins 24 are received in the passages 214, a portion of the connecting pin 24 is supported in the passage 214 so that after all the connecting pins 24 are supported by the passages 214, the connecting pins 24 are at the same level.

Because the connecting pins 24 are at the same level, the connection between the connecting pins 24 and the terminals 22 is easy and also the connection of the connecting pins 24 to the substrate 23 is convenient.

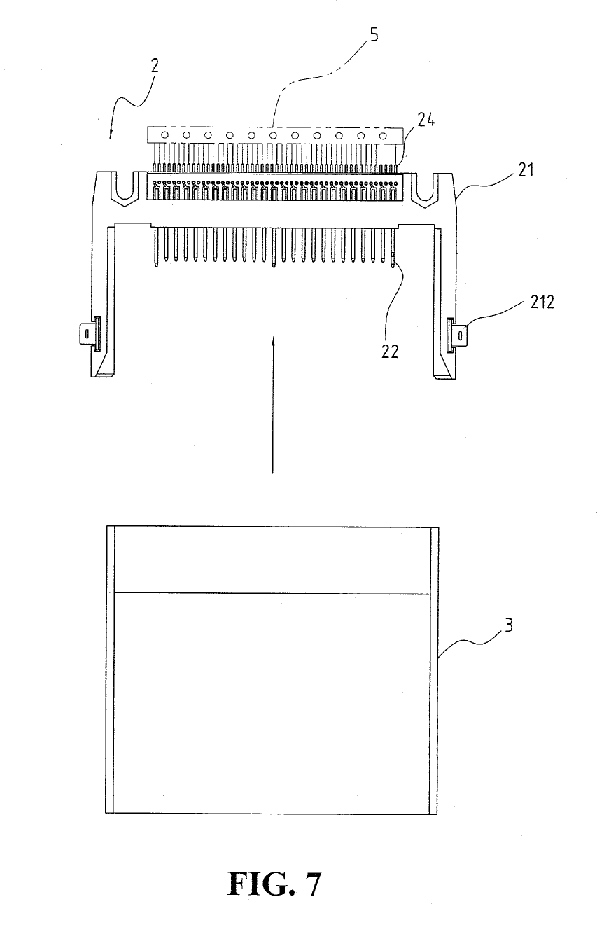

With reference to FIG. 7, it is seen that the body 21 is U shape and the terminals 22 extend out of the body 21. With the terminals 22, a memory cartridge 3 is able to be inserted into the body 21 so that the memory cartridge 3 is able to have connection to the substrate 23 by the terminals 22. Furthermore, a belt 5 is attached to the connecting pins 24 before the installation of the connecting pins 24 are inserted into the passages 214 such that all the connecting pins 24 are maintained at the same level before inserting into the body 21.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a memory cartridge connector having a U-shaped body, terminals, a substrate and connecting pins, wherein the improvements comprise:
the U shaped body having through holes defined therethrough for insertion of the terminals which extend from opposite sides of the body, the rear ends of the terminals connecting to the substrate,
the body having passages defined in a bottom of the body, wherein a width and a depth of the passages are the same as those of the connecting pins,
wherein one end of the connecting pin is received in a corresponding one of the passages and extends out of the body, the other end of the connecting pin connects to a corresponding one of the terminals, whereby after all the connecting pins are received in the passages, a portion of the connecting pin is supported in the passage so that after all the connecting pins are supported by the passages so that the connecting pins are at the same level.

2. The connector as claimed in claim 1, wherein the connecting pin is L-shaped.

3. The connector as claimed in claim 1, wherein the connecting pin connects to a corresponding one of the terminals.
